(19) United States
(12) Patent Application Publication
(10) Pub. No.: US 2021/0199791 A1
(43) Pub. Date: Jul. 1, 2021

(54) TIRE MONITORING DEVICES SYSTEMS AND METHODS

(71) Applicant: VAYYAR IMAGING LTD., Yehud (IL)

(72) Inventors: Ian Podkamien, Petah Tivka (IL); Shay Moshe, PETAH-TIKVA (IL)

(21) Appl. No.: 17/138,016

(22) Filed: Dec. 30, 2020

Related U.S. Application Data
(60) Provisional application No. 62/954,736, filed on Dec. 30, 2019.

(51) Int. Cl. G01S 13/60; G01S 13/08; G01B 15/00; B60C 23/04

(52) U.S. Cl. CPC G01S 13/60; B60C 23/0488; G01B 15/00; G01S 13/08

(57) ABSTRACT

A radar sensing system for estimating one or more of a vehicle's wheel parameters, including an antenna subsystem comprising one or more RF (Radio Frequency) antennas configured and enabled to transmit one or more RF signals from at least one RF antenna towards one or more selected directions or points and obtain reflected or affected plurality of RF signals from the one or more selected directions or points, a data acquisition subsystem configured and enabled to measure the axle-to-ground clearance and the axle-to-chassis clearance, and one or more processors configured and enabled to estimate the one or more of the vehicle's wheel parameters.

### CROSS-REFERENCE

The present application claims priority to U.S. Provisional Application Ser. No. 62/954,736 filed on Dec. 30, 2019, entitled “TIRE MONITORING DEVICES SYSTEMS AND METHODS” (attorney docket no. VY026/USP2) which is incorporated herein by reference in its entirety.

### TECHNICAL FIELD

The present invention relates generally to devices, systems and methods for real-time monitoring of one or more tires or overall tilt/roll of for example a vehicle.

### BACKGROUND OF THE INVENTION

The need to maintain tires at the correct pressure level to eliminate driving on under-inflated tires is fundamental in preventing undue tread wear, increased fuel consumption and flat tire accidents.

Known solutions for measuring pressure level include for example TPMS (Tire Pressure Monitoring System). A TPMS is an electronic system designed to monitor the air pressure inside the pneumatic tires on various types of vehicles. TPMS reports real-time tire-pressure information to the driver of the vehicle, either via a gauge, a pictogram display, or a simple low-pressure warning light. TPMS can be divided into two different types—direct (dTPMS) and indirect (iTPMS). TPMS are provided both at an OEM (factory) level as well as an aftermarket solution. The target of a TPMS is avoiding traffic accidents, poor fuel economy, and increased tire wear due to under-inflated tires through early recognition of a hazardous state of the tires.

Other known solutions include for example tire condition monitoring systems (TCMS) including MEMS (Micro Electro Mechanical System) sensors such as pressure sensors, accelerometers, and temperature sensors used to measure pressure, vibration, and temperature of the tire. Occasionally such sensors are installed on the wheel or inside the tire, necessitating data transfer from a rotating part to the vehicle's computer system.

Known solutions for measuring RPM (Round per Minute) include for example using encoders mounted on the wheel.

The prior art monitor systems can be less than ideal in at least some respects. The monitoring systems can be larger than ideal including ruggedized parts requiring expensive maintenance. Additionally, as a result of using many mechanical parts and moving parts, the prior art solutions are typically inaccurate and as a result, the reliability of these monitoring systems is low.

### SUMMARY OF THE INVENTION

According to a first embodiment, there is provided a radar sensing system for estimating one or more of a vehicle's wheel parameters, the radar sensing system comprising: an antenna subsystem comprising one or more RF (Radio Frequency) antennas configured and enabled to: transmit one or more RF signals from at least one RF antenna of said one or more RF antennas towards one or more selected directions or points; obtain reflected or affected plurality of RF signals from said one or more selected directions or points; a transmit-receive subsystem configured and enabled to: generate the one or more RF signals; couple the generated RF signals to the one or more antennas; receive reflected RF signals from the one or more antennas and convert them into a form suitable for acquisition; a data acquisition subsystem configured and enabled to: measure the axle-to-ground clearance and the axle-to-chassis clearance; and one or more processors configured and enabled to: receive the measured axle-to-ground clearance and the axle-to-chassis clearance of the vehicle; and estimate the one or more of said vehicle's wheel parameters

In an embodiment, the vehicle's wheel parameters are one or more of: tire pressure; weight applied on the wheel.

In an embodiment, the radar sensing system is further configured to measure the axle-to-ground clearance and the axle-to-chassis clearance of the vehicle over time.

In an embodiment, the radar sensing system is one of an ultrawideband radar or a millimeter-wave radar.

In an embodiment, the vehicle comprises a plurality of wheels and a radar sensing system is mounted in proximity to at least two wheels of the plurality of wheels.

In an embodiment, the system is further configured to estimate the disbalance in the load applied on the plurality of wheels.

In an embodiment, the radar is selected from a group consisting of:

a pulse radar; stepped frequency radar; or a FMCW radar.

In an embodiment, the radar sensing system is a MIMO (multi-input multi-output) radar.

In an embodiment, the radar sensing system is mounted on an axle of the wheel or on the chassis of the vehicle.

In an embodiment, the radar sensing system is mounted in proximity to each wheel of the plurality of wheels.

In an embodiment, the system comprising a communication subsystem for transmitting the measured axle-to-ground clearance and the axle-to-chassis clearance from the radar sensing system to the vehicle's processors.

In an embodiment, the measured axle-to-ground clearance and the axle-to-chassis clearance are processed at the vehicle's processors to yield one or more of the vehicle's wheel parameters.

In an embodiment, the antenna subsystem comprises a plurality of antennas wherein a first subset of antennas of said plurality of antennas is directed down towards the ground with respect to the vehicle and a second subset of antennas of said plurality of antennas is directed towards the vehicle chassis.

In an embodiment, the antenna subsystem comprises a plurality of antennas wherein a first subset of antennas of said plurality of antennas is configured to measure the axle-to-ground clearance and the axle-to-chassis clearance of the vehicle and a second subset of antennas of said plurality of antennas is directed sideways towards the wheel which is in proximity to the radar sensing system, and wherein based on signals received at the second subset of antennas the one or more processors are configured to estimate wheel rotation speed.

In an embodiment, the antenna subsystem comprises a third subset of antennas of said plurality of antennas wherein the third subset of antennas is directed sideways towards the wheel which is in proximity to the radar sensing system, and wherein based on signals received at the third subset of antennas the one or more processors are configured to estimate wheel rotation speed.

In an embodiment, the data acquisition subsystem is further configured and enabled to collect and digitize the received reflected signals from the transmit-receive subsystem; and measure delay, Doppler frequency shift and amplitude fluctuation rate of the received signals with respect to the transmitted signals.

According to a second embodiment, there is provided a method for estimating one or more of a vehicle's wheel parameters using a radar sensing system, the method comprising: transmitting one or more RF signals, from the radar sensing system in the direction of the vehicle's chassis and the ground; receiving respectively reflected signals from the vehicle's chassis and the ground below the vehicle; collecting and digitizing the received signals for measuring the axle-to-ground clearance and the axle-to-chassis clearance; analyzing the axle-to-ground clearance and the axle-to-chassis clearance to estimate one or more parameters of the vehicle's wheel or wheels.

In an embodiment, the method further comprising: collecting and digitizing the received signals for measuring the delays and frequency shifts of the received signals with respect to the transmitted one or more signals; analyzing the delays and frequency shifts of the received signals for evaluating the vehicle's wheel rotation speed.

In an embodiment, the one or more parameters of the vehicle's wheels are: tire pressure; weight applied on the wheels.

In an embodiment, the method further comprising transmitting one or more RF signals from the radar sensing system in the direction of the vehicle's wheel.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1A shows a block diagram of the radar sensing system and a vehicle, in accordance with embodiments;

FIG. 1B shows a high-level block diagram of the radar sensing system of FIG. 1A, in accordance with embodiments;

FIG. 1C shows a detailed block diagram of the radar sensing system, in accordance with another embodiment;

FIG. 2A shows a bottom side view of the vehicle and a sensing system configured and enabled to measure axle-to-ground clearance and the axle-to-chassis clearance, in accordance with embodiments;

FIG. 2B shows a radar sensing system mounted on the chassis and configured to measure chassis-to-ground and chassis-to-axle distances, in accordance with another embodiment;

FIG. 3 shows a flowchart of a method for estimating one or more parameters of the vehicle's wheels, in accordance with embodiments; and

FIGS. 4A-4B show a radar sensing system embedded in the bottom part of each of the vehicle's doors, in accordance with embodiments.

### DETAILED DESCRIPTION OF THE INVENTION

The devices, systems and methods, in accordance with embodiments, are configured and enabled to monitor the status of one or more tires using for example a compact sensing device, installed in a concealed manner, without mechanical moving parts and without need for maintenance.

Specifically, the systems and methods comprise a radar sensing system for monitoring the axle-to-ground clearance, the axle-to-chassis clearance and optionally the rotational velocity of the wheel, in order to estimate the wheel's parameters such as the wheel's tire pressure. In accordance with embodiments, clearance (e.g. distance) and rotational velocity are found by transmitting RF signals and measuring the delay and frequency shift (or amplitude fluctuation rate) respectively of the reflected received RF signals.

With specific reference now to the drawings in detail, it is stressed that the particulars shown are by way of example and for purposes of illustrative discussion of the preferred embodiments of the present technique only, and are presented in the cause of providing what is believed to be the most useful and readily understood description of the principles and conceptual aspects of the present technique. In this regard, no attempt is made to show structural details of the present technique in more detail than is necessary for a fundamental understanding of the present technique, the description taken with the drawings making apparent to those skilled in the art how the several forms of the invention may be embodied in practice.

Before at least one embodiment of the present technique is explained in detail, it is to be understood that the invention is not limited in its application to the details of construction and the arrangement of the components set forth in the following description or illustrated in the drawings. The present technique is applicable to other embodiments or of being practiced or carried out in various ways. Also, it is to be understood that the phraseology and terminology employed herein is for the purpose of description and should not be regarded as limiting.

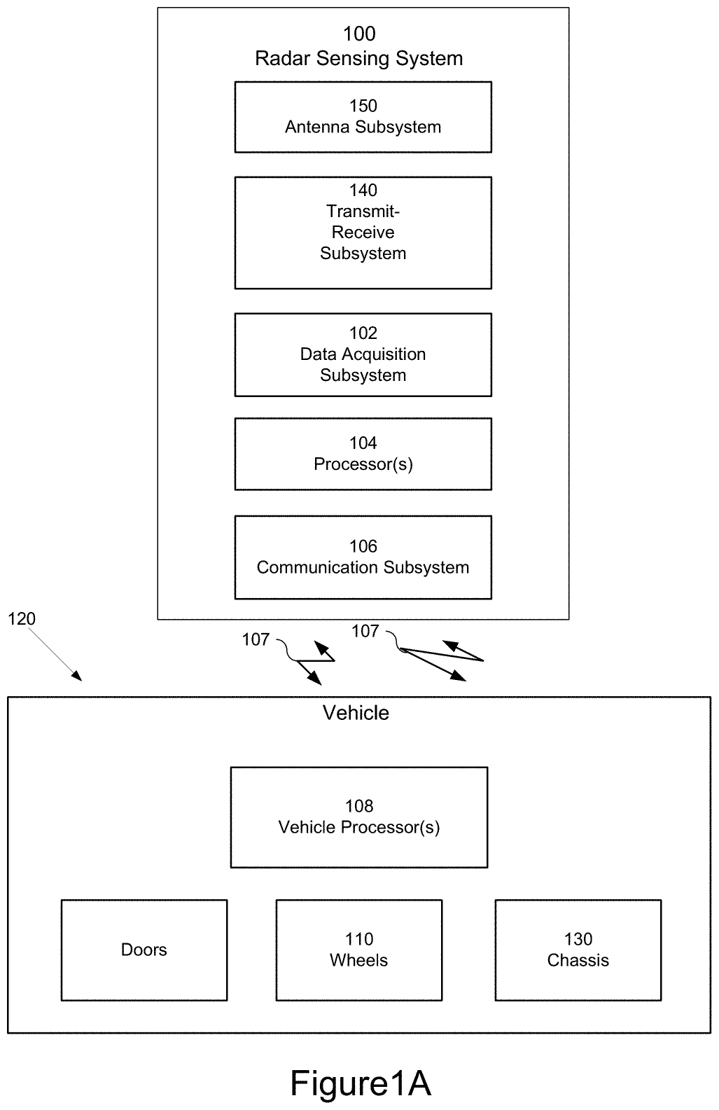

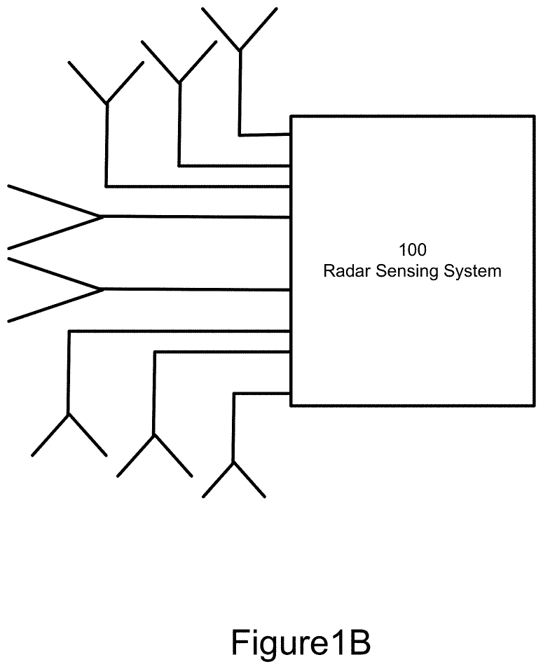

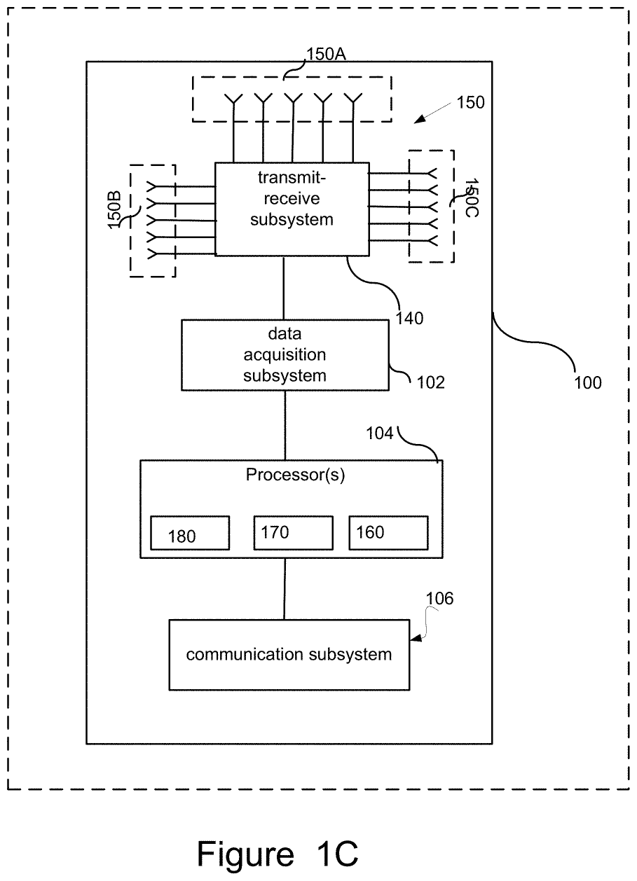

FIG. 1A shows a block diagram of the radar sensing system 100 and a vehicle 120, in accordance with embodiments. The radar sensing system 100 comprises an antenna subsystem 150, a transmit-receive subsystem 140, a data acquisition subsystem 102, one or more processors 104, and a communication subsystem 106. The antenna subsystem 150 comprises one or more antennas. In some embodiments, the antenna subsystem 150 may comprise a plurality of antennas which may be divided to one or more subset of antennas or to one or more RF antenna arrays.

The radar sensing system 100 is configured and enabled to estimate wheel(s) parameters such as the wheel tire pressure and/or the plurality of the vehicle's wheels tire pressure by measuring the distance from one or more predefined selected points in the vehicle or vehicle's units to other one or more one or more preselected points. For example, the distance may be the axle-to-ground clearance and/or the axle-to-chassis clearance. Alternatively or in combination, the radar sensing system 100 is configured and enabled to monitor and estimate other one or more of the vehicles' wheels parameters, such as the rotational velocity RPM (Rounds Per Minute) of the wheel(s). It is understood that reference to “a vehicle's wheel parameters” shall mean one or more parameters of one or more of the wheels on a vehicle.

In some embodiments, the radar sensing system is a MIMO (multi-input multi-output) radar.

In operation, one or more of the vehicle's parameters such as the distances (e.g. axle-to-ground clearance and/or the axle-to-chassis clearance) are found by transmitting one or more RF signals towards one or more selected directions or points, for example to the ground, obtaining reflected or affected plurality of RF signals from the one or more selected directions or points and measuring the delay of the reflected received RF signals. Accordingly, based on the measured distances the one or more of the vehicle's wheel(s) parameters are estimated. Similarly, the wheel rotational velocity is found by transmitting one or more RF signals, for example towards the wheel and measuring the Doppler frequency shift (or amplitude fluctuation rate) of the reflected received RF signals.

In accordance with some embodiments, the RF signals may be directed from the RF antennas to selected points or locations in the vehicle.

In accordance with embodiments, the signals are directed to the selected points according to the location of the antennas with respect to the vehicle and the vehicles' wheels.

According to one embodiment, the measured vehicle's parameters (e.g. distances) are transmitted by the communication subsystem 106 from the radar sensing system 100, for example via a wired or wireless communication links 107, to the vehicle's processor(s) 108 for processing the vehicle's measured parameters (e.g. distances) and estimating one or more of the vehicle's wheel parameters such as tire pressure and the like.

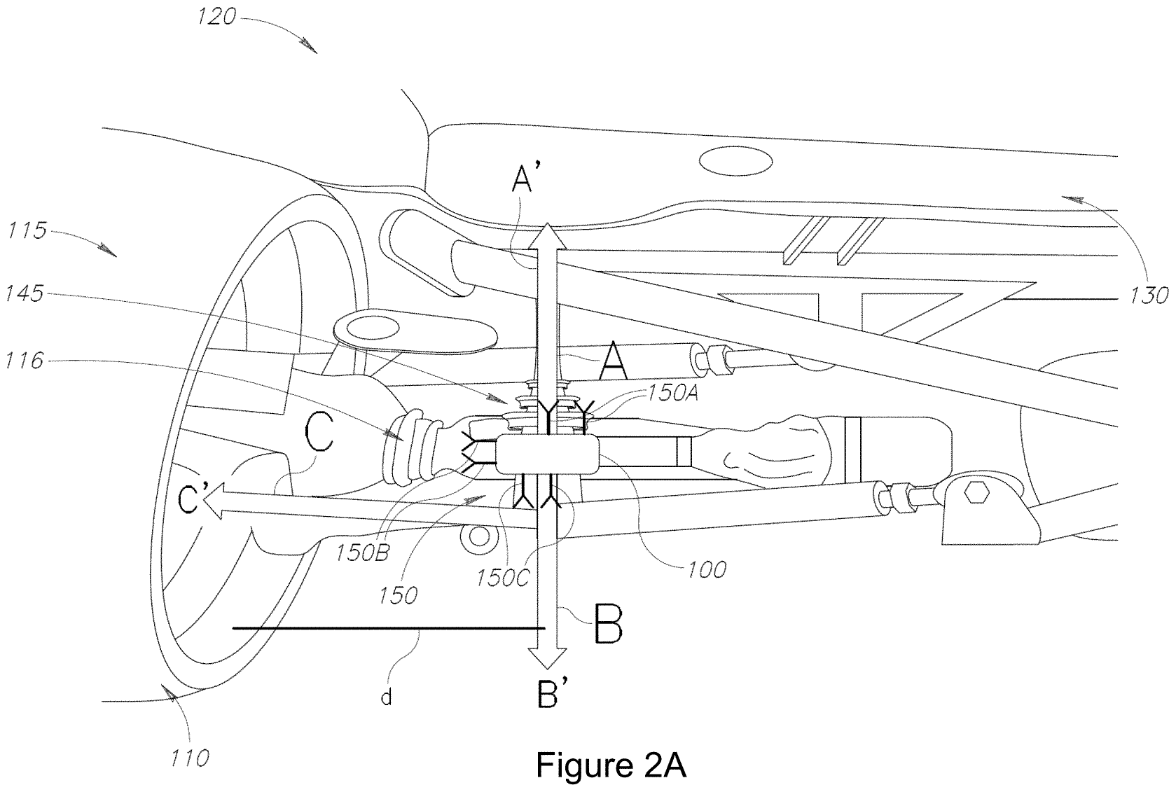

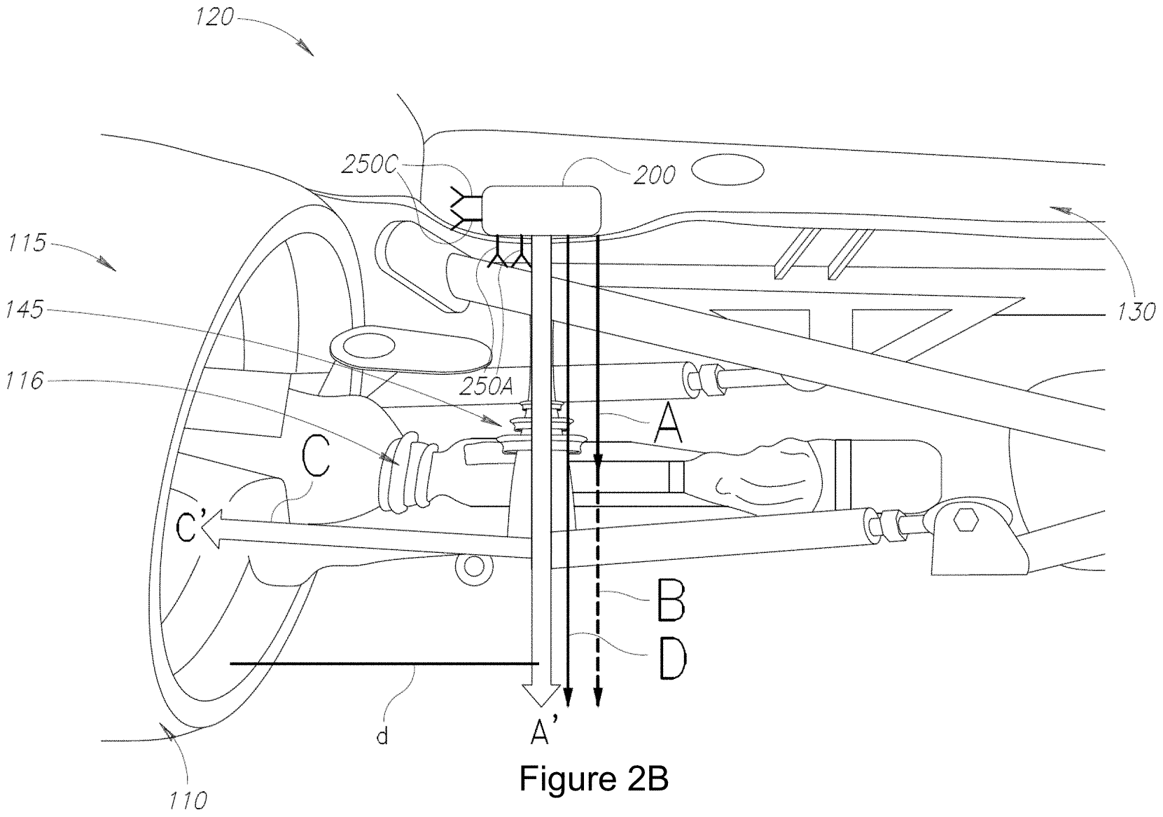

In accordance with embodiments, the radar sensing system 100 may be mounted in proximity to the vehicle's wheels, for example at a distance d from the wheel (e.g. 1, 5, 10, 50, 200 or more cm) as illustrated in FIG. 2A. In some cases, the system may be mounted on one or more or on each of the wheel's axis or/and the wheelhouse and/or the suspension strut and/or the wheel's stabilizer.

In some cases, the radar sensing system 100 may be attached or embedded in the wheels axis 145 or the wheels axis area, as illustrated for example in FIG. 2A.

In accordance with embodiments, the radar sensing system 100 may be mounted on the vehicles chassis or in proximity to the vehicle chassis for measuring the distance from the chassis to the axle and from the chassis to the ground, as illustrated for example in FIG. 2B.

In accordance with embodiments, the radar sensing system 100 may be mounted on the vehicle's doors or in proximity to the vehicle's doors.

FIGS. 2A shows a bottom side view of a vehicle 120, the vehicle's chassis 130, vehicle's suspension system 116, vehicle's wheel 115 and tire 110 and the radar sensing system 100 configured and enabled to monitor the axle-to-ground clearance and the axle-to-chassis clearance of the vehicle and estimate the tire pressure of the wheel 115, for example over time, in accordance with embodiments.

In accordance with one embodiment, the antenna subsystem 150 comprises a plurality of RF antennas which may be divided to three subsets of RF antennas or three antenna arrays such as a first subset of antennas 150A, a second subset of antennas 150B and a third subset of antennas 150C, wherein each subset of antennas includes multiple antenna elements. For example, as illustrated in FIG. 2A, subset of antennas 150A is directed up (e.g. to look up) in the direction of arrow A′ (in the direction of the chassis) to enable measuring for example the distance A to the vehicle chassis 130, subset of antennas 150B is directed down in the direction of arrow B′ (e.g. to the ground) to enable measuring, for example, the distance B to the ground, and subset of antennas 150C is directed sideways toward the wheel 115 (e.g. the wheel which is in proximity to the radar sensing system) in the direction of arrow C′ to enable measuring, for example, the rotational velocity RPM (Rounds Per Minute) of the wheel 110. For the case where the wheel's rotational velocity estimation is not required, system 100 comprises only two subsets of antennas such as subset of antennas 150A and subset of antennas 150B.

Specifically, each subset of antennas 150A, 150B and 150C may include multiple antenna elements, such as RF antenna elements, typically between a few and several dozen (for example 30) antennas. The antennas can be of many types known in the art, such as printed antennas, waveguide antennas, dipole antennas or “Vivaldi” broadband antennas. The subset of antennas can be linear or two-dimensional, flat or conformal to the region of interest.

According to some embodiments, each antenna array or subset of antennas may be or may include an array or a plurality of flat broadband antennas, for example, spiral-shaped antennas. The unique and optimized shape of the antennas enables their use in limited sized devices, such as thin, small-sized sensors. In addition, the use of an antenna that is shaped as flat as possible, for example in a printed circuit, allows for the linkage of the radar sensing system 100 to any device in the vehicle, as it does not take up much space, it is not cumbersome, nor does it add significant weight to the vehicle.

In some cases, the radar sensing system 100 may be a standalone unit, including one or more processors 104 configured and enabled to process the obtained radar measurements (e.g. distance) and compute one or more of the vehicle's wheel parameters such as tire pressure. The radar sensing system 100 may be connected or in communication with the vehicle's processor(s) (e.g. computer) 108 to transfer the parameters via wired or wireless communication link such as USB, Bluetooth™ or any electronic connection as known in the art.

In some other cases, processor 104 included in the radar sensing system 100 performs only limited processing of the radar measurements, while most of the processing required for example to compute tire pressure based on the obtained radar measurements is performed by the vehicle processor(s) 108, which is connected to or in communication with the radar sensing system 100 via wired or wireless connections such as USB, Bluetooth™ or any electronic connection as known in the art.

FIG. 1C shows a high-level block diagram of the radar sensing system 100 of FIG. 1A, in accordance with embodiments.

FIG. 1D shows a detailed block diagram of the radar sensing system 100, in accordance with another embodiment. The radar sensing system 100 may include the transmit-receive subsystem 140 connected to the antenna subsystem 150 comprising for example the three antenna subset of antennas 150A, 150B and 150C, the data acquisition subsystem 102, the processor(s) subsystem 104 and the communication subsystem 106.

According to some embodiments, each antenna array or subset of antennas comprises two or more antenna elements. The transmit-receive subsystem 140 comprises a plurality of transceivers with at least one transceiver attached to each antenna array or subset of antennas, the at least one transceiver is configured to transmit at least one signal toward the vehicle's units and receive a plurality of signals reflected by the medium.

According to some embodiments, the radar sensing system 100 is configured and enabled to monitor the status of one or more units, devices or systems of the vehicle. Specifically, the radar sensing system 100 is configured and enabled to monitor the axle-to-ground clearance, the axle-to-chassis clearance (e.g. distance) of the vehicle, in order to estimate the tire pressure of the wheel. In addition, the rotational velocity of the vehicle wheel may be also monitored.

The transmit-receive subsystem 140 is responsible for the generation of the microwave signals, coupling them to the subset of antennas (e.g. antenna arrays), receive the microwave signals from the subset of antennas and converting them into a form suitable for acquisition. The signals (e. g. multiple sets of RF signals) can be pulse signals, stepped-frequency signals, chirp signals and the like. The generation circuitry can involve oscillators, synthesizers, mixers, or it can be based on pulse oriented circuits such as logic gates or step-recovery diodes. For example, these signals may be microwave signals in the UWB band 3-10 Ghz (having a wavelength of 3-10 cm in air). The conversion process can include down-conversion, sampling, and the like. The conversion process typically includes averaging in the form of low-pass filtering, to improve the signal-to-noise ratios and to allow for lower sampling rates.

Nonlimiting examples of system 100 or transmit-receive subsystem 140 may include Vayyar' s VYYR2401 or VYYR7201 multichannel transceiver RFIC. Another exemplary implementation of the transmit-receive subsystem 140 may include Infineon' s millimeter-wave multichannel transceiver at 60 GHz and 77 GHz bands.

In operation, the data acquisition subsystem 102 collects and digitizes the received signals from the transmit/receive subsystem 104 while tagging the signals according to the antenna combination used and the time at which the signals were collected. The data acquisition subsystem will typically include analog-to-digital (A/D) converters and data buffers, and it may include additional functions such as signal averaging, correlation of waveforms with templates or converting signals between frequency and time domain. In addition, the data acquisition subsystem includes the functions required to measure delay, Doppler frequency shift and amplitude fluctuation rate of the received signals with respect to the transmitted signals.

In accordance with embodiments, the processor(s) 104 is configured and enabled to convert the collected time delay and Doppler frequency shift (or amplitude fluctuation rate) measurements into a set of responses (e.g. distance and rotational velocity).

In cases where system 100 is a standalone unit, the processor(s) 104 further analyzes the responses to monitor the vehicle's units and devices such as wheels and estimate one or more of the vehicle's wheel(s) parameters such as: tire pressure; weight applied on each or all the vehicle's wheels (e.g. load); wheel rotation speed. Specifically, the processor(s) 104 may further comprise a distance estimation software module 160, tire pressure software module 170 and load calculation module 180.

The resulting wheel's parameters data is transferred to the vehicle processor 108, for further processing, storage, display, tracking over time, statistics gathering etc. The data is transferred a via wired or wireless communication subsystem 106.

In some cases, the estimation of the wheel's parameters (e.g. tire pressure) based on the received responses (e.g. distance, rotational velocity) is performed by the vehicle processor 108, instead of processor 104. Thus, the vehicle processor includes the required functionality such as distance estimation software module 160, tire pressure software module 170 and load calculation module 180. The required data is transferred to the vehicle processor via wired or wireless communication subsystem 106.

In some cases, the radar sensing system 100 may be included within a housing such as a case or within a system configured to be attached to one of the vehicle's units such as the wheels axis 145. In another embodiment, the housing is configured to be attached to the vehicle's chassis.

In some embodiments, the radar sensing system 100 may utilize the vehicle's data processing display, storage and analysis subsystems.

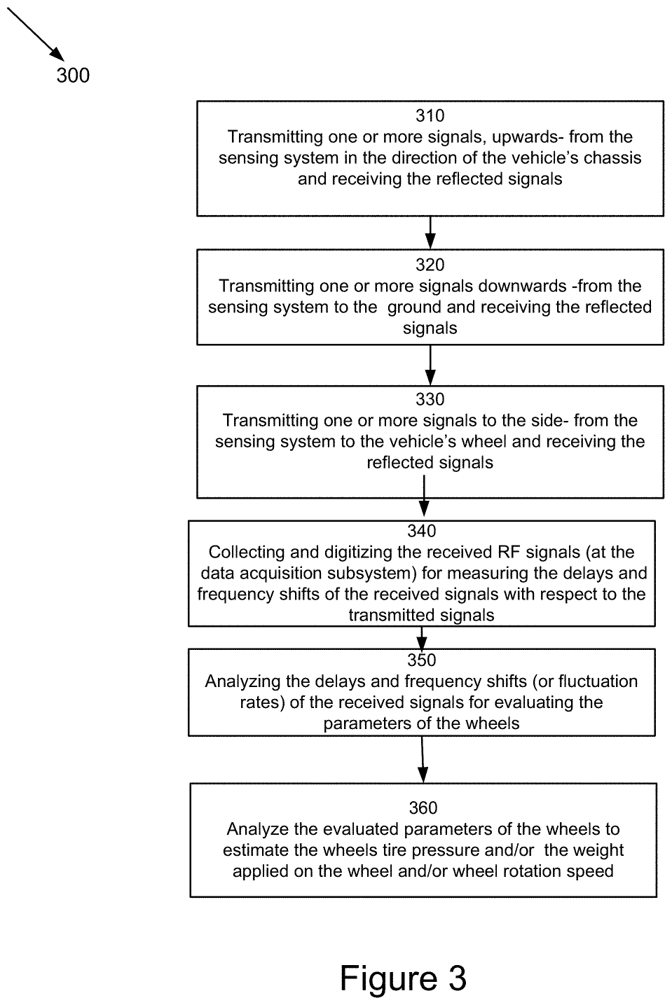

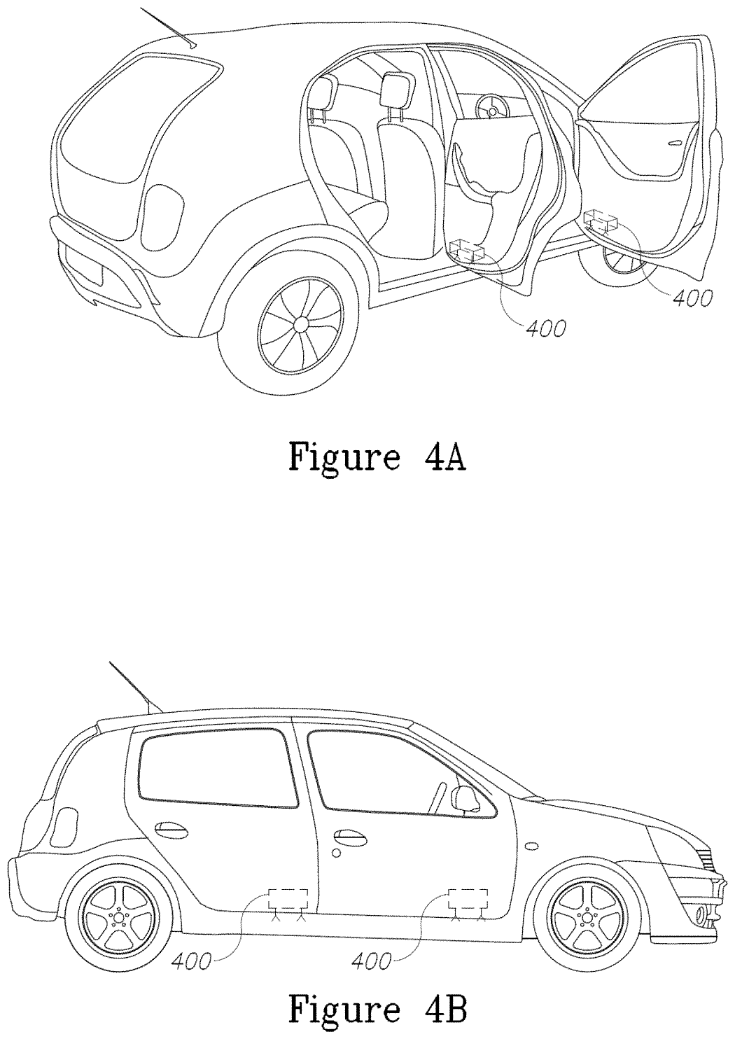

In some embodiments, as illustrated in FIG. 2B, a radar sensing system 200 may be mounted on the chassis and configured to measure chassis-to-ground and chassis-to-axle distances. In some embodiments the radar sensing system 200 may be or may include elements of the radar sensing system 100. For example, the radar sensing system 200 may include a single set of antennas such as RF subset of antennas 250A for measuring the vehicle's parameters (e.g. axle-to-chassis and chassis-to-ground clearance) and further to estimate the wheels' parameters such as tire pressure. Specifically, subset of antennas 250A is directed down in the direction of arrow A′ for measuring for example the distance A from the chassis to the vehicle axis, and further for measuring for example the distance D from the chassis to the ground. The measured distance A is subtracted from the measured distance D to yield distance B which is the axle-to-ground distance. Based on the measured distances A and B the wheel parameters are estimated as explained in details hereinbelow with respect to FIG. 3 and FIG. 4.

Optionally, the radar sensing system may include an additional subset of antennas, such as subset of antennas 250C which is directed sideways toward the wheel 210 in the direction of arrow C′ to enable measuring for example the rotational velocity RPM (Rounds Per Minute) of the wheel 210.

FIG. 3 illustrates a flowchart of method 300 for estimating one or more parameters of the vehicle's wheels, e.g. tire pressure and/or weight applied on the wheel, in accordance with embodiments. System 100, for example, may be used to implement method 300, however, method 300 may also be implemented by systems having other configurations, with the appropriate adaptations.

At step 310 one or more signals, such as one or more RF signals are transmitted upwards in the direction of the vehicle's chassis. For example, as illustrated in FIG. 1A signals may be transmitted from subset of antennas 150A in the direction of arrow A′ towards the vehicle's chassis and the reflected signals received at the subset of antennas 150A. At step 320 one or more signals, such as one or more RF signals are transmitted downwards towards the ground (e.g. the ground below the vehicle) and the reflected signals are received. For example, as illustrated in FIG. 1A signals may be transmitted from subset of antennas 150B in the direction of arrow B′ towards the ground and the reflected signals received at the subset of antennas 150B. At step 230 one or more signals, such as one or more RF signals are transmitted sideways towards the direction of the vehicle's wheel and the reflected signals received. For example, as illustrated in FIG. 1A the signals may be transmitted from subset of antennas 150C in the direction of arrow C′ to the wheel 110 and the reflected signals received at the subset of antennas 150C.

At step 340 the multiple sets of reflected RF signals received respectively at the subset of antennas 150A, 150B and 150C are sent to the data acquisition subsystem 106 for collecting and digitizing the signals and extracting the delay and Doppler frequency shift (or amplitude fluctuation rate) of the received signals with respect to the transmitted signals.

At step 350 the measured delays, frequency shifts (or amplitude fluctuation rates) are analyzed, for example by the one or more processors, for evaluating one or more parameters of the vehicle. The one or more parameters of the vehicle include the distance of the radar sensing system to the vehicle chassis, the distance of the radar sensing system to the ground and the wheel's RPM (Rounds Per Minute). The RPM of the wheel may be measured by Doppler frequency shift analysis of radar returns from the wheel, or from rate of fluctuation of the reflected signals due to spokes or other wheel's structural elements.

In an embodiment, such as illustrated in FIG. 2B, the radar sensing system 200 is attached to vehicle's chassis and the transmissions from a subset of antennas e.g. 250A are directed towards the axle and the ground. The chassis-to-axle and chassis-to-ground distances are measured and their subtraction yields the axle-to-ground distance.

At step 360 the measured parameters are further analyzed to estimate the wheel's tire pressure and/or the weight applied on the wheel and/or wheel rotation speed.

In some embodiments, the tire pressure and the vehicle load on the wheel are estimated from the measured chassis-to-axle distance A and axle-to-ground distance B, by solving the following set of equations:

A=F1(vehicle load)

B=F2(vehicle load, tire pressure)

where F1(load) and F2(load, tire pressure) are vehicle dependent functions known to the vehicle manufacturer.

In some cases, the radar sensing system with one or more subset of antennas may be attached or embedded in one or more of vehicle doors. For example, as illustrated in FIG. 4A and FIG. 4B a radar sensing system 400 may be embedded in the bottom part of each of the vehicle's doors, with a set (e.g. of one or more) subset of antennas directed downwards, the system can provide the distance of the door to the ground. Doing that on all four doors may provide an overall tilt/roll of the vehicle—which is indicative to load distribution of the vehicle. This can be used for driving assistance compensations (like steering compensation, braking, etc.). Alternatively, four radar sensing systems may be attached on front/rear, left/right sides of the vehicle yielding an overall tilt/roll an overall tilt/roll indication of the vehicle.

In some embodiments, the radar sensing system 400 may be the radar sensing system 100 or radar sensing system 200.

In accordance with some embodiments, the methods and systems are applicable to all types of vehicles with multiple doors, such as cars, trucks and the like.

In further embodiments, the processing unit may be a digital processing device including one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, the system disclosed herein includes one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device.

In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media. In some embodiments, the system disclosed herein includes at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof. In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In some embodiments, the system disclosed herein includes software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In some embodiments, the system disclosed herein includes one or more databases, or use of the same. In view of the disclosure provided herein, those of skill in the art will recognize that many databases are suitable for storage and retrieval of information as described herein. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention. Furthermore, it is to be understood that the invention can be carried out or practiced in various ways and that the invention can be implemented in embodiments other than the ones outlined in the description above. It is to be understood that the terms “including”, “comprising”, “consisting” and grammatical variants thereof do not preclude the addition of one or more components, features, steps, or integers or groups thereof and that the terms are to be construed as specifying components, features, steps or integers.

It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included. Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A radar sensing system for estimating one or more of a vehicle's wheel parameters, the radar sensing system comprising:
an antenna subsystem comprising one or more RF (Radio Frequency) antennas configured and enabled to:
transmit one or more RF signals from at least one RF antenna of said one or more RF antennas towards one or more selected directions or points;
obtain reflected or affected plurality of RF signals from said one or more selected directions or points;
a transmit-receive subsystem configured and enabled to:
generate the one or more RF signals;
couple the generated RF signals to the one or more antennas;
receive reflected RF signals from the one or more antennas and convert them into a form suitable for acquisition;
a data acquisition subsystem configured and enabled to:
measure the axle-to-ground clearance and the axle-to-chassis clearance;
and one or more processors configured and enabled to:
receive the measured axle-to-ground clearance and the axle-to-chassis clearance of the vehicle; and
estimate the one or more of said vehicle's wheel parameters.

2. The radar sensing system of claim 1, wherein the vehicle's wheel parameters are one or more of:
tire pressure; weight applied on the wheel.

3. The radar sensing system of claim 1, wherein the radar sensing system is further configured to measure the axle-to-ground clearance and the axle-to-chassis clearance of the vehicle over time.

4. The radar sensing system of claim 1, wherein the radar sensing system is one of an ultrawideband radar or a millimeter-wave radar.

5. The radar sensing system of claim 1, wherein the vehicle comprises a plurality of wheels and a radar sensing system is mounted in proximity to at least two wheels of the plurality of wheels.

6. The radar sensing system of claim 5, wherein the system is further configured to estimate the disbalance in the load applied on the plurality of wheels.

7. The radar sensing system of claim 1 wherein the radar is selected from a group consisting of:
a pulse radar; stepped frequency radar; or a FMCW radar.

8. The radar sensing system of claim 1, wherein the radar sensing system is a MIMO (multi-input multi-output) radar.

9. The radar sensing system of claim 1, wherein the radar sensing system is mounted on an axle of the wheel or on the chassis of the vehicle.

10. The radar sensing system of claim 5, wherein a radar sensing system is mounted in proximity to each wheel of the plurality of wheels.

11. The radar sensing system of claim 1, comprising a communication subsystem for transmitting the measured axle-to-ground clearance and the axle-to-chassis clearance from the radar sensing system to the vehicle's processors.

12. The radar sensing system of claim 11, wherein the measured axle-to-ground clearance and the axle-to-chassis clearance are processed at the vehicle's processors to yield one or more of the vehicle's wheel parameters.

13. The radar sensing system of claim 1, wherein the antenna subsystem comprises a plurality of antennas, wherein a first subset of antennas of said plurality of antennas is directed down towards the ground with respect to the vehicle and a second subset of antennas of said plurality of antennas is directed towards the vehicle chassis.

14. The radar sensing system of claim 1, wherein the antenna subsystem comprises a plurality of antennas, wherein a first subset of antennas of said plurality of antennas is configured to measure the axle-to-ground clearance and the axle-to-chassis clearance of the vehicle and a second subset of antennas of said plurality of antennas is directed sideways towards the wheel which is in proximity to the radar sensing system, and wherein based on signals received at the second subset of antennas the one or more processors are configured to estimate wheel rotation speed.

15. The radar sensing system of claim 13, wherein the plurality of antennas comprises a third subset of antennas, wherein the third subset of antennas is directed sideways towards the wheel that is in proximity to the radar sensing system, and wherein, based on signals received at the third subset of antennas, the one or more processors are configured to estimate wheel rotation speed.

16. The radar sensing system of claim 1, wherein the data acquisition subsystem is further configured and enabled to collect and digitize the received reflected signals from the transmit-receive subsystem; and
measure delay, Doppler frequency shift and amplitude fluctuation rate of the received signals with respect to the transmitted signals.

17. A method for estimating one or more wheel parameters of a vehicle using a radar sensing system, the method comprising:
transmitting one or more RF signals, from the radar sensing system in the direction of the vehicle's chassis and the ground;
receiving respectively reflected signals from the vehicle's chassis and the ground below the vehicle;
collecting and digitizing the received signals for measuring the axle-to-ground clearance and the axle-to-chassis clearance;
analyzing the axle-to-ground clearance and the axle-to-chassis clearance to estimate one or more wheel parameters of at least one of the vehicle's wheels.

18. The method of claim 17, further comprising:
collecting and digitizing the received signals for measuring the delays and frequency shifts of the received signals with respect to the transmitted one or more signals;
analyzing the delays and frequency shifts of the received signals for evaluating the vehicle's wheel rotation speed.

19. The method of claim 17, wherein the one or more wheel parameters of the at least one of the vehicle's wheels are:
tire pressure; weight applied on the wheels.

20. The method of claim 17, further comprising transmitting one or more RF signals from the radar sensing system in a direction of the at least one of the vehicle's wheels.
